(19) United States
(12) Patent Application Publication
(10) Pub. No.: US 2004/0172213 A1
(43) Pub. Date: Sep. 2, 2004

(54) Motion analyzing device

(76) Inventor: Raimo Olavi Kainulainen, Lahti (FI)

Correspondence Address: YOUNG & THOMPSON, 745 SOUTH 23RD STREET 2ND FLOOR, ARLINGTON, VA, 22202

(21) Appl. No.: 10/483,072

(22) PCT Filed: Jul. 11, 2002
(86) PCT No.: PCT/FI02/00631

(30) Foreign Application Priority Data
Jul. 11, 2001 (FI) 20011518

(51) Int. Cl. G06F 15/00

(52) U.S. Cl. 702/141

(57) ABSTRACT

The present invention relates to an apparatus for recording and analyzing the trajectory of a body part of a player or athlete during the physical motion performed by the individual, the apparatus being attached to the body part of the individual. The apparatus comprises means for recording the duration of the motion, sensors for measuring at least one acceleration component value of the motion of at least the body part being monitored and for indicating the time-related acceleration component of the motion, processor means for processing the time-related acceleration component values into a graphical form and display means for representing the result in a graphical form.

The present invention relates to a device suited for analyzing the trajectory of a body part of a player or athlete during a physical motion performed by an individual in order to bring about an improvement in the level of achievement and accuracy of the individual's performance.

For instance, long practicing is necessary to master a perfect golf swing. At least 100,000 swings are required to root the swing dynamics in the automatic routines of muscle control so that the entire swing can be carried out as simply as gait. Hence, it is important to learn the swing correctly from the first beginning. Otherwise the swing may become a kind of combination of errors repeated from swing to swing.

A swing comprises a sequence of movements performed by the different parts of an individual's body in a given order. It is important that the tempo of the movements is correct in regard to each other. It is also important to aim at long drives in order to improve the score of a play. However, it is typical for nonprofessional golfers in particular to misuse the momentum of their body by assuming incorrect tempo, whereby it becomes impossible to develop maximum speed exactly at the instant the club head impacts the ball.

Among other things, an ideal swing is characterized by two extremely important parameters, namely, the tempo and timing of the impact. However, these details are the most difficult to learn inasmuch the golfer him/herself cannot see such things. The instant of the club head impact with the ball is also so short that it is not detectable by the eye.

The golfer's tempo should repeat unchanged from one swing to another. Furthermore, the swing tempo learned on a practice range should be repeatable as such on a competition driving range. The only difference between a practice range and a competition driving range is that on a practice range the golfer can strike as many times as is necessary to lean the correct tempo. In contrast, playing on a driving range is limited to one stroke at a time and each one of the strokes should be perfect. During the game and thereafter, it is very difficult to analyze the real factors causing bad strokes.

Given all other factors being correct, incorrect tempo invariably leads to a bad stroke.

Moreover, the golfer him/herself cannot possibly know whether the club impacts the ball at the very instant of maximum speed of the club that obviously could drive the ball at maximum velocity.

Most golfers appear to have an incorrect timing of the impact instant throughout their entire playing career. One reason is that there has not been any chance of receiving reliable feedback on the tempo of the swing.

In conventional golf swing analysis systems, the equipment performing the measurements has generally comprised a device placed on a platform and adapted to measure one or more swing parameters such as club head velocity or direction. These embodiments have been handicapped by not being portable so that the golfer could carry the equipment during a game of golf or on a practice range in order to record information on swing dynamics, whereby they have failed to record simultaneously a plurality of parameters such as the speed of the golfer's arms or the timing of the ball impact relative to the speed of the arms or the club head that could give useful information for improving the swing performance. Conventional equipment also is incapable of measuring the tempo of the different body parts relative to each other and the motion parameters of the club.

It is an object of the present invention to aid a golfer to analyze on a practice range and also on a driving range his/her swings thereby improving the score of games. The apparatus according to the invention also makes it possible to record during the swing, for instance, the motion parameters of arms and other body parts in addition to recording the instant of ball impact. The apparatus processes the recorded data into reports that indicate, e.g., the speed of arms in the different phases of a swing and the timing of the instant of the actual ball impact relative to the former. Additionally, it is possible to determine the overall duration of the swing divided into the durations of the backswing and actual downswing. Other parameters of importance include the repeatability and variance of swing duration from stroke to stroke.

In addition to hands, also other body parts may be arranged to carry sensors measuring the motion parameters in order to record motion parameters thereof, whereby the apparatus can be used for printing reports or gathering data for tempo analysis of the different phases of the overall swing performance.

While the present application elucidates the use of the invention in the analysis of a golf swing, obviously the invention may as well be utilized in other ball games such as the American baseball, the Finnish softball or tennis and squash, for example, involving accurate timing of the instant of ball impact, whereby a person skilled in the art can readily appreciate the capabilities of the invention in the improvement of performance in such games particularly in conjunction with professional sports aiming at maximum performance.

The goal of the invention may be attained in the spirit of the invention as characterized in detail in the appended claims.

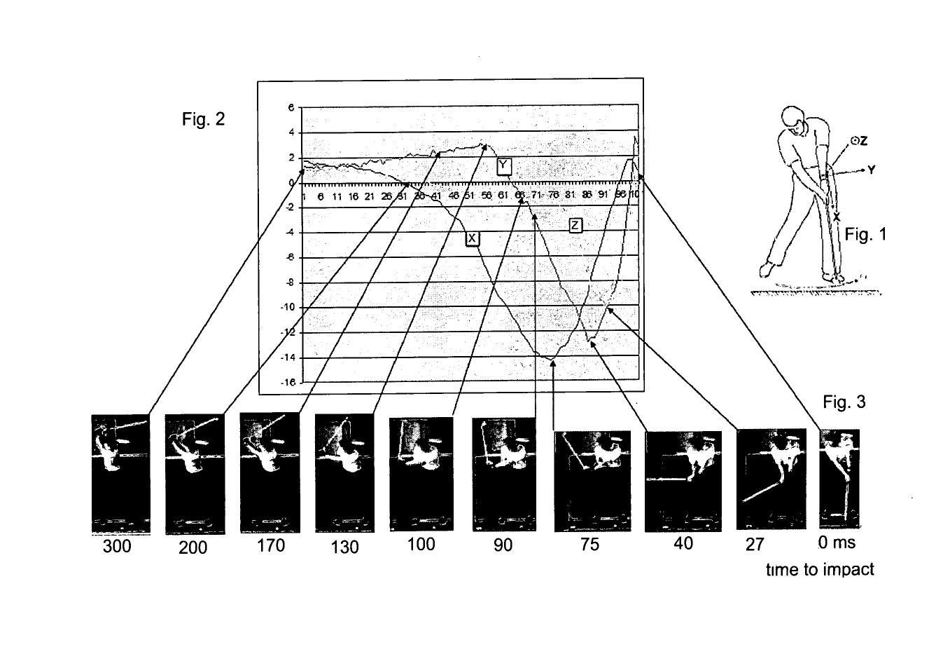

Next, the invention will be elucidated with the help of the attached diagrams of an exemplifying embodiment showing the use of an apparatus according to the invention in the recording and outlining of a golf swing by means of three-dimensional acceleration measurements. In the illustrated case, the apparatus is attached to the left hand wrist of a right-handed golfer. The apparatus includes sensors for measuring acceleration in directions X, Y, Z as shown in FIG. 1. Measurements in direction X are chiefly related to the centrifugal acceleration of the arms, while the rotation of the arms can be sensed in direction Y and the movements of the left hand back in direction Z. The different motion phases of a swing are illustrated in FIG. 3, and FIG. 2 shows a graph computed and processed from the measured acceleration values recorded in the above-mentioned directions.

Inspection of the graph of FIG. 2 allows a very accurate analysis of the different phases of the swing. Using a display device, the invention makes it possible to plot on the screen a set of reference graphs with which the graph of the swing can be compared. The reference graphs may include, e.g., a graph recorded from the measurement values of the golfer's preceding swing, an averaged graph computed from a plural number of the golfer's preceding swings, a deviation graph of swings or a graph representing an ideal swing. The plot of an ideal swing may be based, e.g., on measurement values recorded from the swings of a professional golfer.

To obtain maximally accurate information of a motion performance, the measurements must be made at a sufficiently frequent temporal rate. In the recording of a golf swing, for instance, the minimum rate of measurements is about 50 samples per second. For more accurate results, measurements should be made at a rate of 200 samples per second during the entire swing.

The measurement sequence performed by the apparatus can be arranged to start activated by a suitable impulse from one of the sensors. For instance, triggering may occur when the backswing of the golf club turns into the swing proper. Respectively, the measurement sequence can be stopped when the system detects an impact with the ball that can be identified very accurately by computational means from the sensed changes in the acceleration measurement value(s). Such an accurately timed instant of ball impact may then be used as a reference datum in the display and analysis of the recorded measurement data.

The processing and memory means of the apparatus are advantageously designed for sufficiently wide capacity allowing the apparatus to utilize self-organizing neural network programs that impart a substantially wider scope to the analysis and training information rendered by the apparatus.

The apparatus may also include appropriate input/output connections or means for receiving information from motion sensors attached to some body parts of the moving individual different from the part having the apparatus attached thereto. Respectively, the system may also receive information on the movements of the play device proper.

Obviously, the apparatus may as well include appropriate input/output connections or means for transfer of stored data to analysis at a suitable external facility.

What is claimed is:

1. An apparatus for recording and analyzing the trajectory of a body part of a player or athlete during the physical motion performed by the individual, the apparatus being attached to said body part of the individual, characterized in that said apparatus comprises means for recording the duration of the motion, sensors for measuring at least one acceleration component of said motion of at least said body part and for indicating said time-related acceleration component value of said motion, processor means for processing said time-related acceleration component values into a graphical form and display means for representing the result in a graphical form.

2. The apparatus of claim 1, characterized in that the apparatus includes sensors for measuring in three dimensions the acceleration components of the motion performed is by said body part of said individual.

3. The apparatus of claim 1 or 2, characterized in that said processing means incorporate means for storage of reference performance data and means for comparison and graphic display of said comparison between said stored reference data and freshly measured data.

4. The apparatus of claim 3, characterized in that said processing means incorporate means for training self-organizing neural network programs.

5. The apparatus of any one of foregoing claims, characterized in that the apparatus includes connections or means for receiving information submitted by sensors located externally in regard to the apparatus.

6. The apparatus of any one of foregoing claims, characterized in that the apparatus includes connections or means for transmitting information to a point located externally in regard to the apparatus.
